(19) United States
(12) Patent Application Publication
(10) Pub. No.: US 2008/0164398 A1
(43) Pub. Date: Jul. 10, 2008

(54) Display support apparatus

(75) Inventors: Dong-Won Choi, Suwon-si (KR); Chil-Sung Lee, Suwon-si (KR); Jae-Kyung Kim, Ansan-si (KR); Jae-Hun Kim, Suwon-si (KR); Kyoung-Shin Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/007,047

(22) Filed: Jan. 4, 2008

(30) Foreign Application Priority Data
Jan. 8, 2007 (KR) 10-2007-0001976

(51) Int. Cl. F16M 11/12; F16M 11/18

(52) U.S. Cl. 248/419; 248/422

(57) ABSTRACT

A display support apparatus, which includes: a stand including a support bar and a base; an arm, of which one end is coupled to the support bar with a lift drive part interposed, such that the arm is movable in a longitudinal direction of the support bar; a connection member, which is coupled to the other end of the arm with a first hinge part interposed, such that the connector member is rotatable in a direction intersecting a direction of gravity; and a movement member, which is coupled to the connection member with a second hinge part interposed, such that the movement member is rotatable in a direction of gravity, where a rotation drive part is coupled to each of the first hinge part and the second hinge part, can rotate the display to provide a viewing angle in correspondence with the position of the viewer.

### CROSS-REFERENCE TO RELATED APPLICATIONS

This application claims the benefit of Korean Patent Application No. 10-2007-0001976 filed with the Korean Intellectual Property Office on Jan. 8, 2007, the disclosure of which is incorporated herein by reference in its entirety.

### BACKGROUND

1. Technical Field

The present invention relates to a display support apparatus.

2. Description of the Related Art

Flat panel displays, such as TV sets and monitors, employing LCD, PDP, LED technology, etc., provide the benefit of allowing efficient use of small spaces, and are fast replacing Braun tube TV's and monitors. The increase in demand for such flat panel displays is expected to continue into the future. In particular, flat panel LCD or PDP TV's, often referred to as “wall-mount TV's,” are affixed to wall surfaces for use. When viewing a wall-mount TV thus affixed, the largest viewing angle is achieved directly in front of the TV.

However, when the TV is fixed to a wall surface, the position that allows the largest viewing angle of the TV screen is also fixed, and as a viewer changes position, adequate viewing may not be obtained.

### SUMMARY

An aspect of the claimed invention is to provide a display support apparatus, which allows the display to rotate and thereby ensures a desired viewing angle, while allowing the display to be rotated with a low-output motor.

One aspect of the invention provides a display support apparatus, which includes: a stand including a support bar and a base; an arm, of which one end is coupled to the support bar with a lift drive part interposed in-between, such that the arm is movable in a longitudinal direction of the support bar; a connection member, which is coupled to the other end of the arm with a first hinge part interposed in-between, such that the connector member is rotatable in a direction intersecting a direction of gravity; and a movement member, which is coupled to the connection member with a second hinge part interposed in-between, such that the movement member is rotatable in a direction of gravity, where a rotation drive part is coupled to each of the first hinge part and the second hinge part.

An elastic member may be coupled between the connection member and the movement member, and may apply an elastic force on the movement member in a direction opposite the direction of gravity.

Also, the rotation drive part may include a motor, and a gear module coupled to the motor that decelerates a rotation speed of the motor.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a display support apparatus according to an embodiment of the present invention.

FIG. 2 is an exploded perspective view of a display support apparatus according to an embodiment of the present invention.

FIG. 3 is a side-elevational view of a display support apparatus with a display coupled on, according to an embodiment of the present invention.

FIG. 4 is a perspective view of a rotation drive part used in a display support apparatus according to an embodiment of the present invention.

### DETAILED DESCRIPTION

The display support apparatus according to certain embodiments of the invention will be described below in more detail with reference to the accompanying drawings. Those components that are the same or are in correspondence are rendered the same reference numeral regardless of the figure number, and redundant explanations are omitted.

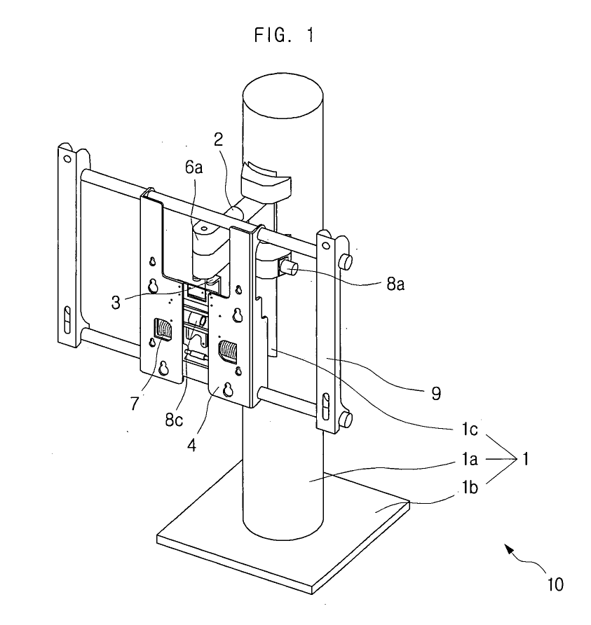

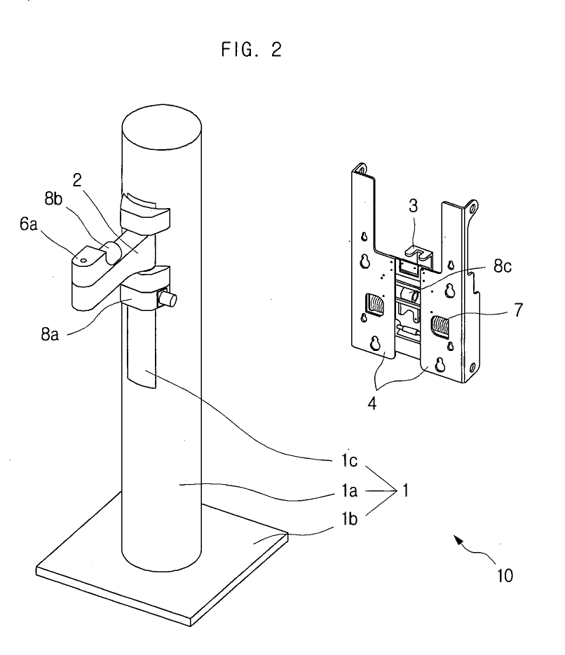

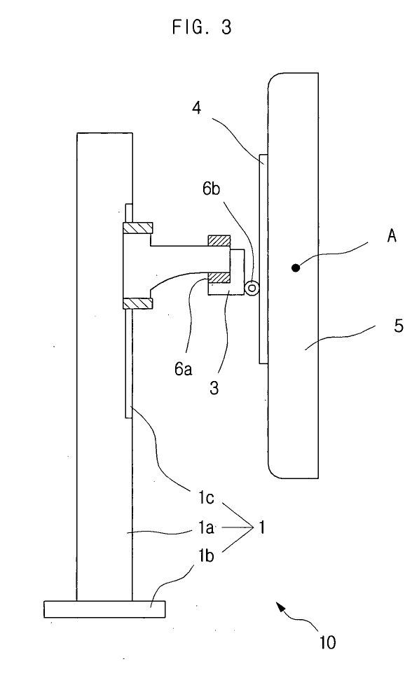

FIG. 1 is a perspective view of a display support apparatus according to an embodiment of the present invention, FIG. 2 is an exploded perspective view of a display support apparatus according to an embodiment of the present invention, and FIG. 3 is a side-elevational view of a display support apparatus with a display coupled on, according to an embodiment of the present invention. In FIG. 1 through FIG. 3, there are illustrated a display support apparatus 10, a stand 1, a support bar 1a, a base 1b, a guide groove 1c, an arm 2, a connection member 3, a movement member 4, a display 5, a first hinge part 6a, a second hinge part 6b, elastic members 7, a lift drive part 8a, rotation drive parts 8b, 8c, and auxiliary members 9.

In describing this embodiment, a “direction of gravity” refers to the direction of gravity pull when the display support apparatus 10 is placed on a flat location, while the “direction intersecting a direction of gravity” refers to a direction that can be perpendicular to the direction of gravity pull. As the “direction of gravity” and the “direction intersecting the direction of gravity” are possible in idealized embodiments, those embodiments having mechanical tolerances and errors in reality are encompassed within the scope of the invention, as are those embodiments that entail intentional tolerances and errors designed around the idealized embodiments.

In the display support apparatus 10 according to this embodiment, one end of the arm 2 can be coupled to the support bar 1a of the stand 1, so that the arm 2 may move along the longitudinal direction of the support bar 1a. The display 5 can rotate about the arm 2 in the direction of gravity, and can be made to rotate in a direction intersecting the direction of gravity.

The display support apparatus 10 of this embodiment can be composed mainly of a stand 1 which may include a support bar 1a and a base 1b, an arm 2 which may have one end coupled to the support bar 1a by way of an interposed lift drive part 8a and which can be lifted in a direction parallel to the direction of gravity, a connection member 3 which may be coupled to the other end of the arm 2 by way of an interposed first hinge part 6a and which can be rotated in a direction intersecting the direction of gravity, and a movement member 4 which may be coupled with the connection member 3 by way of an interposed second hinge part 6b and which can rotate in the direction of gravity.

The stand 1 may be composed mainly of the base 1b and the support bar 1a, while a guide groove 1c may additionally be formed which can be coupled to one end of the arm 2 and along which the arm 2 may move. The base 1b can be the member that is placed on the floor, and can have a sufficiently broad surface to advantageously support the arm 2 and the display 5. The support bar 1a may be coupled in a perpendicular configuration to the center of the base 1b. The support bar 1a can have the form of a rod, or can be a board-shaped member, etc.

The arm 2 may be coupled on one end to the support bar 1a with the lift drive part 8a interposed in-between. Thus, the arm 2 can be made to move automatically along the longitudinal direction of the support bar 1a. The lift drive part 8a may mainly include a motor and a gear module, and may additionally include chains, belts, gears, etc., within a range that allows the arm 2 to move in the longitudinal direction of the support bar 1a. The components of the lift drive part 8a can be coupled to the support bar 1a or to the arm 2.

The connection member 3 may be coupled on the other end of the arm 2 with the first hinge part 6a interposed in-between, to allow rotation in a direction intersecting the direction of gravity. A rotation drive part 8b may be coupled to the first hinge part 6a, to allow the connection member 3 to rotate automatically.

The movement member 4 may be coupled to the connection member 3 with the second hinge part 6b interposed in-between. The movement member 4 may rotate in the direction of gravity relative to the connection member 3. Of course, it is apparent that the movement member 4, after having rotated in the direction of gravity, can rotate back in a direction opposite the direction of gravity, to return to its original position. A rotation drive part 8c may be coupled also to the second hinge part 6b. A display 5 may be coupled to the movement member 4. To facilitate the coupling between the movement member 4 and the display 5, additional auxiliary members 9 may be coupled to the movement member 4, as illustrated in FIG. 1.

As such, when a display 5 is coupled to the movement member 4, the display support apparatus 10 according to this embodiment may render the display 5 movable along the longitudinal direction of the support bar 1a and rotatable in the direction of gravity and in the direction intersecting the direction of gravity at the other end of the arm 2.

In cases where there are no apparatuses added between the display 5 and the movement member 4, the display 5 may droop downwards about the second hinge part 6b due to the pull of gravity. Therefore, in order to keep the display 5 horizontal with respect to gravity, elastic members 7 may be coupled between the connection member 3 and the movement member 4, as illustrated in FIG. 2. The elastic members 7 may apply elastic forces in a direction opposite the direction of gravity, to prevent the display 5 from drooping downwards. The coupling position of the display 5 and the second hinge part 6b may also be important in reducing the drooping of the display 5. As illustrated in FIG. 3, forming the second hinge part 6b at a position lower than the center of mass (A) of the display 5 can reduce the gravitational moment of the display 5, so that the elastic members 7 may be able to maintain the display 5 parallel to the direction of gravity with a minimal amount of elastic force.

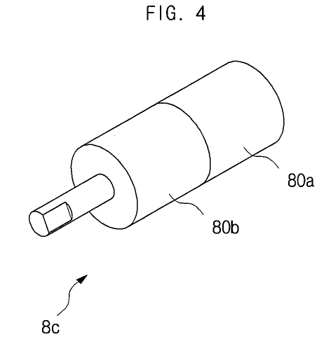

A rotation drive part 8c may be coupled to the second hinge part 6b. As illustrated in FIG. 4, the rotation drive part 8c may include a motor 80a and a gear module 80b. The gear module 80b may serve to decelerate the rotation speed of the motor 80a and increase the final output torque. The rotation drive part 8c enables the movement member 4 to rotate in the direction of gravity. The rotation drive part 8c may include several gear members (e.g. worm gear, etc.) necessary for rotating the movement member 4.

Of course, the lift drive part 8a and the rotation drive part 8b may also include gear modules, motors, and other necessary gear members, etc.

According to certain embodiments of the invention as set forth above, by coupling the display to the stand using an arm, the contents of the display can be viewed with less restrictions in terms of space, and the display can be made to rotate in a direction intersecting the direction of gravity and can be tilted in the direction of gravity at the end of the arm, providing a wider range of viewing angles.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A display support apparatus comprising:
a stand comprising a support bar and a base;
an arm having one end thereof coupled to the support bar by way of a lift drive part interposed in-between such that the arm is movable in a longitudinal direction of the support bar;
a connection member coupled to the other end of the arm by way of a first hinge part interposed in-between such that the connector member is rotatable in a direction intersecting a direction of gravity; and
a movement member coupled to the connection member by way of a second hinge part interposed in-between such that the movement member is rotatable in the direction of gravity,
wherein a rotation drive part is coupled to each of the first hinge part and the second hinge part.

2. The display support apparatus of claim 1, wherein an elastic member is coupled between the connection member and the movement member, and the elastic member applies an elastic force on the movement member in a direction opposite the direction of gravity.

3. The display support apparatus of claim 1, wherein the rotation drive part comprises:
a motor; and
a gear module coupled to the motor and configured to decelerate a rotation speed of the motor.
